(19) United States
(12) Patent Application Publication
(10) Pub. No.: US 2022/0346360 A1
(43) Pub. Date: Nov. 3, 2022

(54) FISHING HOOK PROTECTORS

(71) Applicant: Gary C Davis, Atascadero, CA (US)

(72) Inventor: Gary C Davis, Atascadero, CA (US)

(21) Appl. No.: 17/233,483

(22) Filed: Apr. 17, 2021

(51) Int. Cl. A01K 97/06

(52) U.S. Cl. CPC A01K 97/06

(57) ABSTRACT

An illustrated view of a fishing hook protector device for protecting a hook point of a fishing hook and a fisherman from being stuck with a fishing hook is presented. The fishing hook protector device is useful for preventing the hook point of the fishing hook from being exposed to the fisherman. The fishing hook protector device is further useful for preventing the hook point of the fishing hook from becoming entangled in and damaging other fishing equipment, such as the fishing line, fishing pole, fishing rod, etc. and damaging the fishing hook itself. The fishing hook protector device is also reusable, convenient and cost effective.

### FIELD OF THE INVENTION

This invention relates to fishing hooks and lures. More particularly, it relates a device for protecting a fisherman from a pointed end of a fishing hook or lure.

### BACKGROUND

Fishing is the activity of trying to catch fish. Fish are often caught in the wild but may also be caught from stocked bodies of water. Techniques for catching fish include hand gathering, spearing, netting, angling and trapping, “Fishing” may include catching aquatic animals other than fish, such as mollusks, cephalopods, crustaceans, and echinoderms. The term is not normally applied to catching farmed fish, or to aquatic mammals, such as whales where the term whaling is more appropriate. In addition to being caught to be eaten, fish are caught as recreational pastimes. Fishing tournaments are held, and caught fish are sometimes kept as preserved or living trophies. When a BioBlitz occurs, fish are typically caught, identified, and then released.

A fish hook or fishhook is a tool for catching fish either by impaling them in the mouth or, more rarely, by snagging the body of the fish. Fish hooks have been employed for centuries by anglers to catch fresh and saltwater fish. In 2005, the fish hook was chosen by Forbes as one of the top twenty tools in the history of man. Fish hooks are normally attached to some form of line or lure which connects the caught fish to the angler. There is an enormous variety of fish hooks in the world of fishing. Sizes, designs, shapes, and materials are all variable depending on the intended purpose of the fish hook.

There are a large number of different types of fish hooks. At the macro level, there are bait hooks, fly hooks and lure hooks. Within these broad categories there are wide varieties of hook types designed for different applications. Hook types differ in shape, materials, points and barbs, and eye type, and ultimately in their intended application. When individual hook types are designed the specific characteristics of each of these hook components are optimized relative to the hook's intended purpose. For example, a delicate dry fly hook is made of thin wire with a tapered eye because weight is the overriding factor. Whereas Carlisle or Aberdeen light wire bait hooks make use of thin wire to reduce injury to live bait but the eyes are not tapered because weight is not an issue. Many factors contribute to hook design, including corrosion resistance, weight, strength, hooking efficiency, and whether the hook is being used for specific types of bait, on different types of lures or for different styles of flies. For each hook type, there are ranges of acceptable sizes. For all types of hooks, sizes range from 32 (the smallest) to 20/0 (the largest).

Hooks a e designed as either single hooks—a single eye, shank and point; double hooks—a single eye merged with two shanks and points; or triple—a single eye merged with three shanks and three evenly spaced points. Double hooks are formed from a single piece of wire and may or may not have their shanks brazed together for strength. Treble hooks are formed by adding a single eyeless hook to a double hook and brazing all three shanks together. Double hooks are used on some artificial lures and are a traditional fly hook for Atlantic Salmon flies, but are otherwise fairly uncommon. Treble hooks are used on all sorts of artificial lures as well as for a wide variety of bait applications.

Bait hook shapes and names include the Salmon Egg, Beak, O'Shaughnessy, Baitholder, Shark Hook, Aberdeen, Carlisle, Carp Hook, Tuna Circle, Offset Worm, Circle Hook, suicide hook, Long Shank, Short Shank, J Hook, Octopus Hook and Big Game Jobu hooks.

Fly hook shapes include Sproat, Sneck, Limerick, Kendal, Viking, Captain Hamilton, Barleet, Swimming Nymph, Bend Back, Model Perfect, Keel, and Kink-shank.

The hook point is probably the most important part of the hook. It is the point that must penetrate fish flesh and secure the fish. The profile of the hook point and its length influence how well the point penetrates. The barb influences how far the point penetrates, how much pressure is required to penetrate and ultimately the holding power of the hook. Hook points are mechanically (ground) or chemically sharpened. Some hooks are barbless. Historically, many ancient fish hooks were barbless, but today a barbless hook is used to make hook removal and fish release less stressful on the fish. Hook points are also described relative to their offset from the hook shank. A kirbed hook point is offset to the left, a straight point has no offset and a reversed point is offset to the right.

Care needs to be taken when handling hooks as they can ‘hook’ the user. If a hook goes in deep enough below the barb, pulling the hook out will tear the flesh. There are three methods to remove a hook. The first is by cutting the flesh to remove it. The second is to cut the eye of the hook off and then push the remainder of the hook through the flesh and the third is to place pressure on the shank towards the flesh which pulls the barb into the now oval hole then push the hook out the way it came in.

Accordingly, and in light of the foregoing, it would be desirable to have a device that can be placed on a fishing hook when not in use to avoid a fisherman from having contact with the fishing hook because being stuck with the fishing hook can cause pain, tearing of the flesh, infection, become entangled with the fishing line, etc. It would be further advantageous if the device were portable, reusable and cost effective. It would further be advantageous for the device to couple to a hook point of the fishing hook such that it does not pierce or damage the device.

### BRIEF DESCRIPTION OF THE DRAWINGS

FIG. 1 is an illustrated view of a fishing hook protector device.

FIG. 2 is an illustrated use of the fishing hook protector device shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

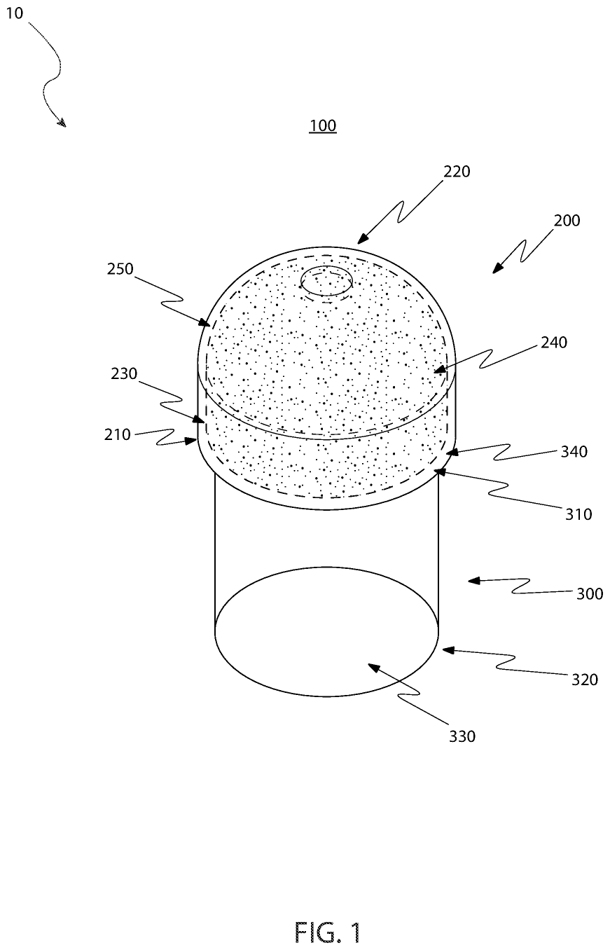

Referring to FIG. 1, an illustrated view of a fishing hook protector device 100 for protecting a hook point of a fishing hook and a fisherman from being stuck with the fishing hook is presented. The fishing hook protector device 100 is useful for preventing the hook point of the fishing hook from being exposed to the fisherman. The fishing hook protector device 100 is further useful for preventing the hook point of the fishing hook from becoming entangled in and damaging other fishing equipment, such as the fishing line, fishing pole, fishing rod, etc. and damaging the fishing hook itself. The fishing hook protector device 100 is also reusable, convenient and cost effective.

The fishing hook protector device 100 has a top portion 200 and a bottom portion 300. The top portion 200 has a bottom end 210, a top 220 and an inside 230. The inside 230 of the top portion 200 of the fishing hook protector device 100 is preferably hollow. The bottom portion 300 has a first end 310, a second end 320 and an interior 330. The interior 330 of the bottom portion 300 of the fishing hook protector device 100 is preferably hollow.

The bottom end 210 of the top portion 200 of the fishing hook protector device 100 is securely coupled to the first end 310 of the bottom portion 300 of the fishing hook protector device 100 by a first coupling agent 340. The first coupling agent 340 is preferably an adhesive material, however other coupling agents are hereby contemplated, including, but not limited to, a single cast mold, rubber cement, two-sided tape, etc.

The fishing hook protector device 100 preferably has a length, in known fishing hook sizing, of 3× Long, however all other fishing hook lengths are hereby contemplated, including, but not limited to, 2× Long, 4× Long, etc. The fishing hook protective device 100 preferably has a width, in known fishing hook sizing, being 3× Wide, however other fishing hook widths are further contemplated, including, but not limited to, 2× Wide, 4× Wide, etc.

The bottom portion 300 of the fishing hook protector device 100 is preferably a cylinder shape, however other shapes are hereby contemplated, including, but not limited to, rectangular, oblong, etc. The bottom portion 300 of the fishing hook protector device 100 is preferably made from a rubber material, however other materials are hereby contemplated, including, but not limited to, poly-vinyl chloride (PVC), nylon, plastic, etc. The bottom portion 300 of the fishing hook protector device 100 is preferably two (2) inches in height, however other heights are hereby contemplated, including, but not limited to, one and one-half (1.5) inches, three (3) inches, etc. The bottom portion 300 of the fishing hook protector device 100 preferably has a diameter of two (2) inches, however other diameters are hereby contemplated, including, but not limited to, one and one-half (1.5) inches, three (3) inches, etc.

The top portion 200 of the fishing hook protective device 100 is preferably a dome shape, however other shapes are hereby contemplated, including, but not limited to, round, square, rectangular, etc. The top portion 200 of the fishing hook protector device 100 is preferably made from a metal material, however other materials are hereby contemplated, including, but not limited to, poly-vinyl chloride (PVC), nylon, plastic, etc. The top portion 200 of the fishing hook protector device 100 is preferably two (2) inches in height, however other heights are hereby contemplated, including, but not limited to, one and one-half (1.5) inches, three (3) inches, etc. The top portion 200 of the fishing hook protector device 100 preferably has a diameter of two and one-half (2.5) inches, however other diameters are hereby contemplated, including, but not limited to, one and one-half (1.5) inches, three (3) inches, etc.

A receiving material 240 is coupled to the inside 230 of the top portion 200 of the fishing hook protector 100 by a second coupling agent 250. The receiving material 240 is preferably a cork material, however other materials are hereby contemplated, including, but not limited to, thermoplastic elastomers, closed-cell polymer mixture, etc. The second coupling agent 250 is preferably an adhesive material, however other coupling agents are hereby contemplated, including, but not limited to, a rubber cement, two-sided tape, etc.

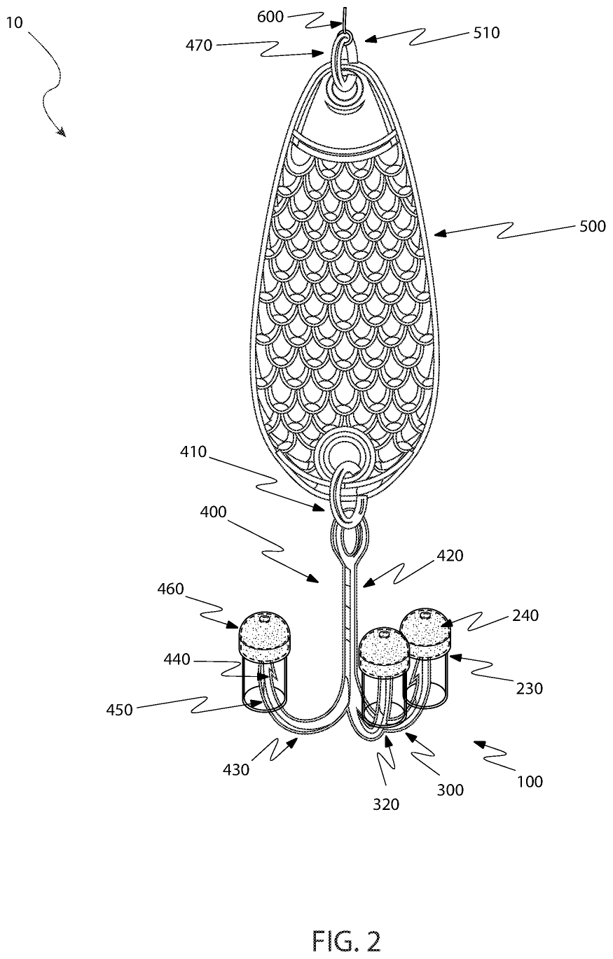

The receiving material 240 is configured to receive the point of the fishing hook such that the point of the fishing hook does not extend through or damage the top portion 200 of the fishing hook protector device 100, thereby increasing the safety realized from the fishing hook protector device 100 and to protect the point and a barb of the fishing hook (see FIG. 2).

Moving now to FIG. 2, an illustrated use of the fishing hook protector device 100 is presented.

A fishing hook 400 has a first eye 410, a shank 420, a bend 430, a barb 440, throat 450 and a point 460. The fishing hook protector device is configured to provide a safe cover from the point 460 of the fishing hook 400 to the bend 430 of the fishing hook 400.

Optionally, and or alternatively, a lure 500 is securely and movably coupled to the first eye 410 of the fishing hook 400 by a lure eye 510. The fishing hook 500 further has a second eye 470. A fishing line 600 of a fishing pole (not shown) is coupled to the second eye 470 of the fishing hook 500 such that the fishing hook 400 and lure 500 are controllable by the fishing pole.

The second end 320 of the bottom portion 300 is configured to receive the point 460 of the fishing hook 400. The fishing hook protector device 100 is pushed down past the barb 440, the throat 450 to substantially near the bend 430. To engage the point 460 into the receiving material 240 of the inside 230 of the top portion 200 of the fishing hook protector device 100, the fishing hook protector device 100 is twisted in a back and forth motion while pushing downward on the fishing hook protector device 100. To remove, the fishing hook protector 100 is again twisted as the fishing hook protector 100 is moved in an upward direction until the fishing hook protector device 100 is removed.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fishing hook protector device for protecting a hook point of a fishing hook and a fisherman from being stuck with a fishing hook, the device consisting of:
a bottom portion, the bottom portion having a first end, a second end and an interior;
a top portion, the top portion having a bottom, a top and an inside, wherein the bottom of the top portion being securely coupled to the first end of the bottom portion by a first coupling agent; and
a receiving material, the receiving material being coupled to the inside of the top portion by a second coupling agent.

2. The device of claim 1, wherein the device having a length of a 3× long fishing hook.

3. The device of claim 1, wherein the device having a width of a 3× wide fishing hook.

4. The device of claim 1, wherein the first coupling agent being made of an adhesive material.

5. The device of claim 1, wherein the second coupling agent being made of an adhesive material.

6. The device of claim 1, wherein the top portion having a dome shape.

7. The device of claim 1, wherein the bottom portion having a cylindrical shape.

8. The device of claim 1, wherein the top portion being made of a metal material.

9. The device of claim 1, wherein the bottom portion being made of a rubber material.

10. The device of claim 1, wherein the bottom portion having a height of two (2) inches.

11. The device of claim 1, wherein the bottom portion having a diameter of two (2) inches.

12. The device of claim 1, wherein the top portion having a diameter of two and one-half (2.5) inches.

13. The device of claim 1, wherein the top portion having a height being two (2) inches.

14. The device of claim 1, wherein the receiving material being a cork material.
